(19) United States
(12) Patent Application Publication
(10) Pub. No.: US 2005/0092378 A1
(43) Pub. Date: May 5, 2005

(54) Structure of an airflow shift switch for compressed air valve

(75) Inventor: Jui-Yi Wu, Pa Deh City (TW)

Correspondence Address: TROXELL LAW OFFICE PLLC, Suite 1404, 5205 Leesburg Pike, Falls Church, VA, 22041, US

(73) Assignee: Chung Shan Golden Dragon Enterprise Co., Ltd.

(21) Appl. No.: 10/805,268

(22) Filed: Mar. 22, 2004

(30) Foreign Application Priority Data
Oct. 31, 2003 (TW) 92219386

(51) Int. Cl. F16K 11/085

(52) U.S. Cl. 137/625.47

(57) ABSTRACT

An airflow shift switch for the compressed air valve comprises a valve seat, an intake stem, a retaining assembly, an intake connector and an nozzle connector, in which when the collar of the intake stem is turned and aligned along the first through hole, the airflow will enter through the intake connector which links to the first through hole and pass a plurality of guides holes on the ring block and penetrate into the inner channel of the intake stem; when the airflow gushes out of the guide holes, there creates a thrust force which bring down the top airflow to move down, the dust or dirt deposited on the top is therefore sucked or removed. This effects dust collection. When the collar is turned to other direction, the airflow will come in through the intake connector and leave the nozzle connector to make it as a dust sweeper.

### BACKGROUND OF THE INVENTION

1. Field of the Invention

This invention relates to a novel structure of airflow shift switch for the compressed air valve which is employed on the sewing machine to perform the dust collection or in other industrial sectors.

2. Description of the Related Art

It is well learned that the dust collection in the prior art of sewing machine uses the lever principle. While the sewing is running, the airflow will enter the air valve and finally into the dust bag, so the dust or cloth odds are therefore brought down into the dust bag together. The dust bag is only useful when the sewing machine is in operation; there is no way for collect the dust or dirt built up the working bench.

### SUMMARY OF THE INVENTION

Due to the limited application, the inventor has advocated great efforts to the research and improvement and finally come up with the compressed air valve with flow control to change the direction of flow and to achieve diverse application.

The main object of this invention is to provide an airflow shift switch for the compressed air valve. When the valve is put in operation, the airflow brought in will be released through the intake stem, so the dust built up on the sewing machine will be gone with the airflow. While the intake stem is turned to another angle to change the direction of the airflow, the airflow comes out of the nozzle connector which serves as a sweeper, or as a driving mechanism. The airflow shift switch presents multiple functions.

This invention will be explained in great detail with the aid of embodiments as illustrated in the drawings attached.

### BRIEF DESCRIPTION OF THE DRAWINGS

FIG. 1 shows the appearance of the airflow shift switch of this invention.

FIG. 2 shows the disassembly of the airflow shift switch of this invention.

FIG. 3 shows the lateral cross section of the airflow shift switch of this invention.

FIG. 4 shows the lateral cross section and intake of the airflow shift switch of this invention.

FIG. 5 shows the cross section block as indicated by arrow 5-5 in the FIG. 1 of the airflow shift switch of this invention.

FIG. 6 shows the process of intake as indicated in FIG. 5 of the airflow shift switch of this invention.

FIG. 7 shows the intake valve stem adjustment directly by manipulating the nozzle outlet.

FIG. 8 shows partial cross section of spring element installation on valve seat.

FIG. 9 shows the airflow shift switch of this invention is in operation.

### DETAILED DESCRIPTION OF THE PREFERRED EMBODIMENT

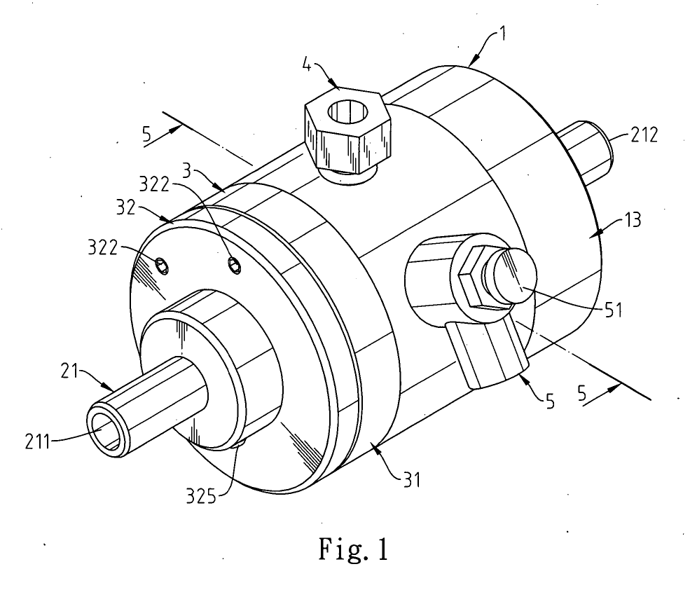

Please refer to FIGS. 1 through 3, the airflow shift switch for the compressed air valve at least consists of a valve seat 1, an intake stem 2, a retaining assembly 3, an intake connector 4 and an nozzle connector 5 where the intake stem 2 will go through the interior of the valve seat 1 for the control the internal airflow.

The valve seat 1 has a large cavity 11 to accommodate the intake stem 2 and the collar 22. At one end of the valve seat 1, there is an outer ring 12 with a protruded post 121. A spring washer 14 is behind the outer ring 12 and two clips 141, 141 of the spring washer 14 will catch the post 121.

There are two go through holes on the valve seat 1, the first go-through hole 112 and the second go through hole 113. The first go through hole 112 connects to the intake connector 4, an O ring 41 and a closer 42. The closer 42 have arc bottom 421 to be fit to the round body of the shaft 21 of the intake stem 2. When the intake stem 2 is turning, the closer 42 can make a hermetic contact to shaft 21 and keep off the air leaking. The second go through hole 113 links to the nozzle connector 5. To prevent air escape form the intake connector 4, there drills a round chute 111 to be inset with an O ring 15 to avert the airflow escaped through crevice.

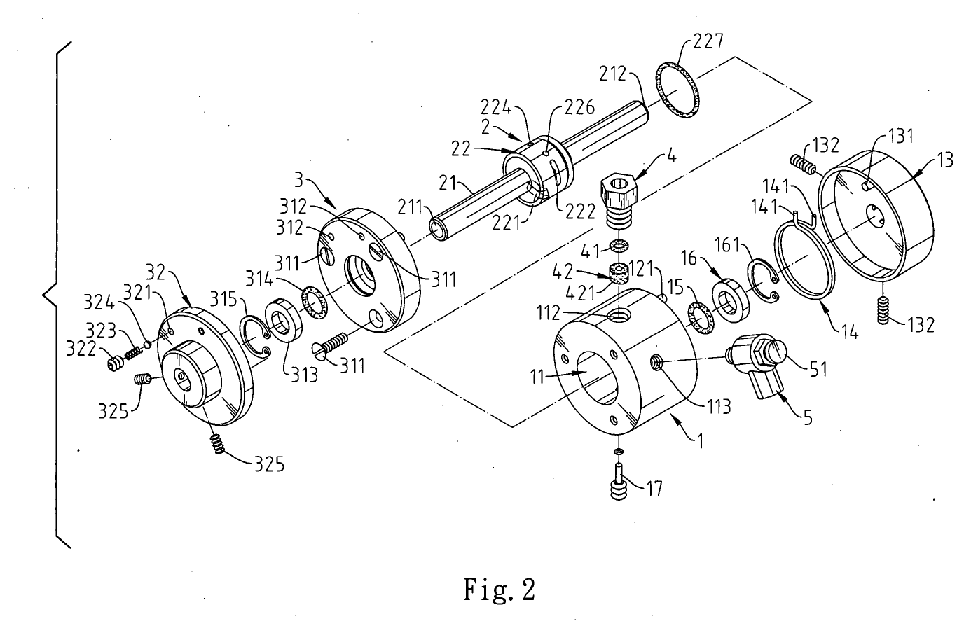

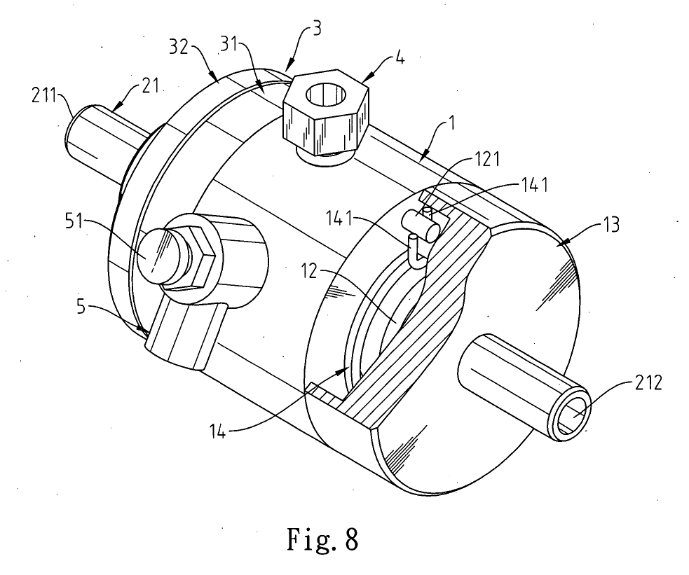

Please refer to FIGS. 2 and 8, besides the outer ring 12, there is a shield cap 13 with a catch 131 which will extend into the gap formed between the clips 141 of the spring washer 14 and the post 121. The shield cap 13 is not welder to the valve seat 1, but locked to the shaft 21 of the intake stem 2 by a set bolt 132. The bearing 16 compensates the rotation of shaft 21 and the shield cap 13. The bearing 15 is held in the interior of valve seat 1 by C clamp 161. When the shield cap 13 is being turned, it deforms the clip 141 of the spring washer 14, and causes the intake stem 2 moving.

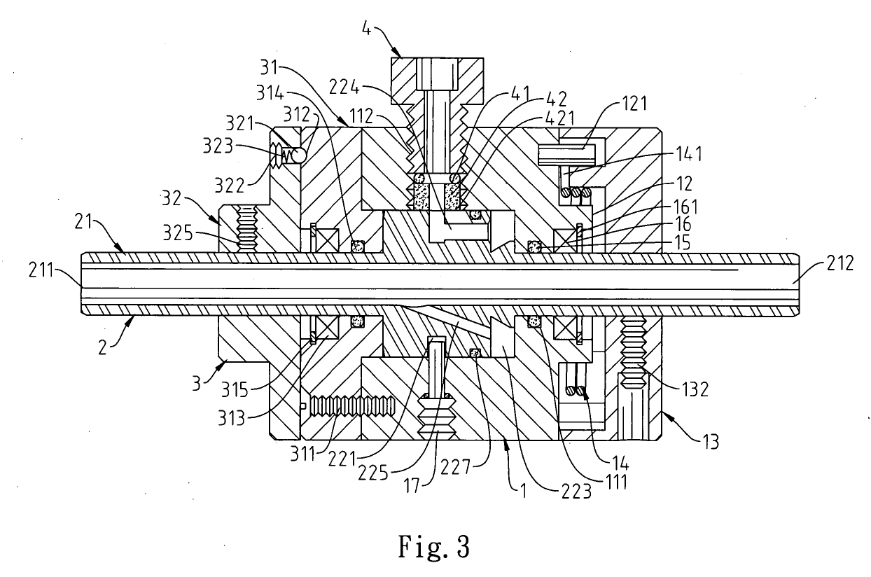

Please refer to FIGS. 2 and 3, the intake stem 2 is installed in the cavity 11 of the valve seat 1, including the shaft 12 and collar 22 and the collar 22 is mounted at the center of the shaft 21. The collar 22 provides an intake hole 224, the ring block 223 is on the top of collar 22, and the intake hole 224 is in L type, and go through to ring block 223, linking to the air hole 226 and the guide chute 222. The air hole 226 and the guide chute 222 are internally communicated.

At the end of collar 22 (same direction of the shield cap 13) there is a ring block 223 with a plurality of inward skew guide holes 225 linked with the go through channel 211 on the shaft 21. The ring block 223 will from a vacuum chamber in the valve seat 1. The L type intake hole 224 also connects to the ring block 223. In this circumstance, the airflow enters the ring block 223 will pass to the channel 211 of the shaft 21 via the guide holes 225. At the other end of the collar 22, there is an indented chute 221 for retaining assembly 3.

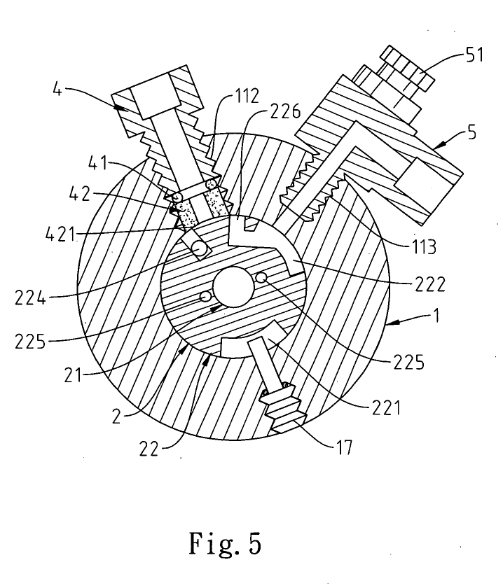

Please refer to FIGS. 2 and 5; the retaining assembly 3 comprises an inner board 31 and a sideboard 32. The bolt 313 locks the inner board 31 onto the valve seat 1 the inner board 31 has a protruded post 311 corresponding to the indent chute 221. When the intake stem 2 is being turned, the post 311 will exert the restraint. The inner board 31 has two indented holes 312 spaced at a fixed distance. The inner board 31 is installed in the sideboard 32 but not locked together; the bolt 325 to the shaft 21 of the intake stem 2 locks the sideboard 32. When the intake stem 2 is being turned the sideboard 32 and the shield cap 13 will move together.

To ensure the proper position after the intake stem 2 is being turned, the indented holes 312 on the inner board 31 are in line with the through hole 323 on the sideboard 32. The through hole 321 will receive the spring 323 and ball 324 in which the ball 324 is pushed by the spring 323 to be inset in the indented holes 312. The through hole 321 is locked with bolt 322 to prevent the spring 323 and the ball 324 falling off the sideboard 32.

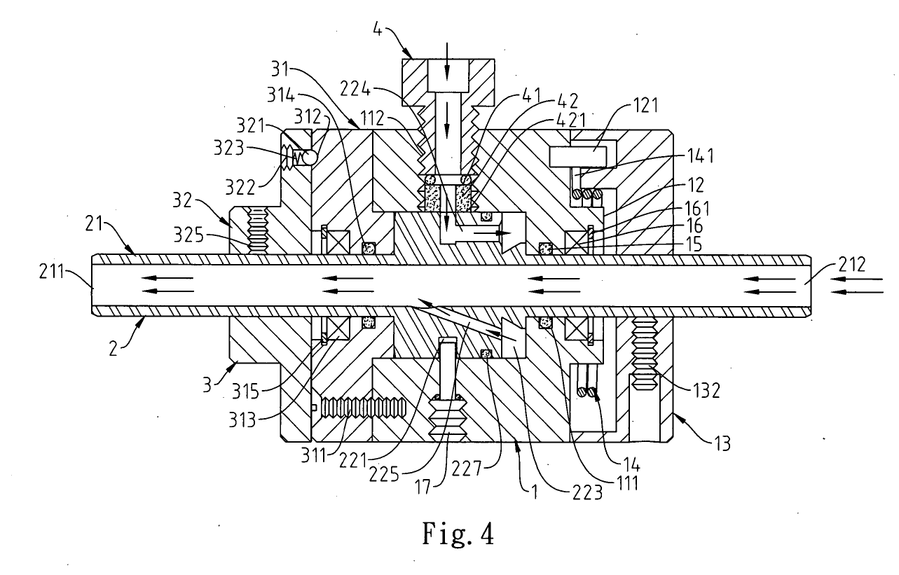

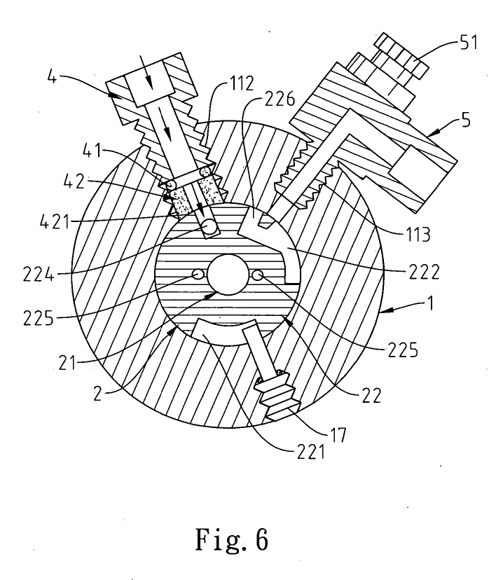

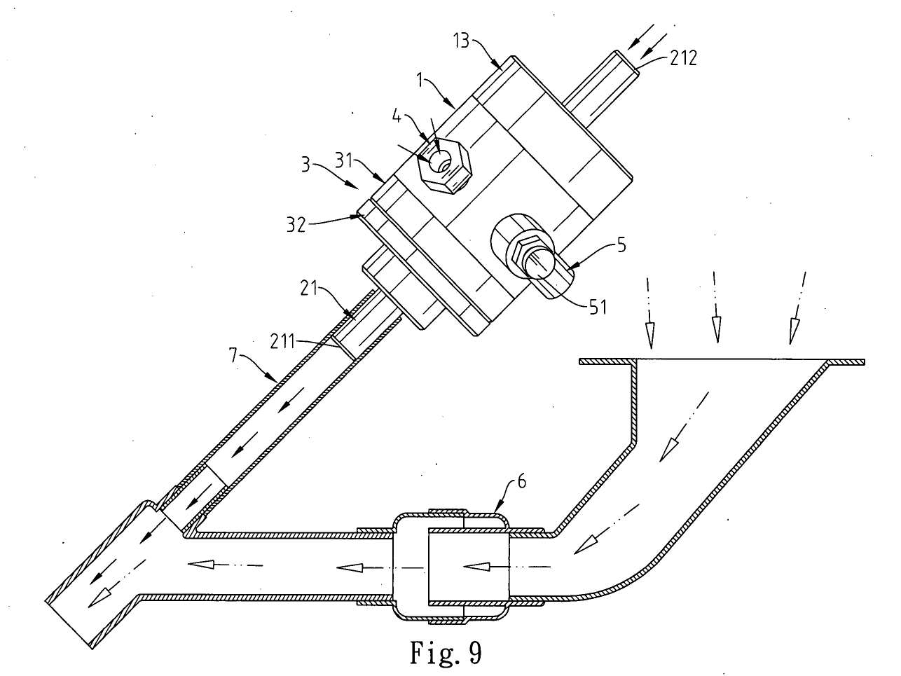

Please refer to FIGS. 4, 5, 6, 8 and 9 to see airflow process. When the intake stem 2 is being turned, the shaft 21 will bring the shield cap 13 to turn, and the catch 131 of the shield cap 13 will deform the spring washer 14. When the turning force on the intake stem 2 is free, the recoil force of the spring washer 14 will return the intake stem 2 to the original position.

When the intake stem 2 is being turned, the intake hole 224 on the collar 22 will be aligned to the first go through hole 112. The stop post 17 within the indented recess 221 restricts the rotation angle of collar 22. The collar 22 will link the closer 42 in the intake connector 4 to the intake hole 224, let the outer air to enter the first go through hole 112 via the intake connector 4 and the intake hole 224. The airflow passes the ring block 223 and guide holes 225 to the through hole 211 of the shaft 21. The airflow which gushes out of the guide hole 225 will produce impact force exerted upon the top end of the shaft 21 of the intake stem 2 to cause the airflow on the top of the shaft 21 move downward. The end of the shaft 21 of the intake stem 2 links to a bleed tube 7 and muffler 6 to gain the noise suppression created in the dust collection.

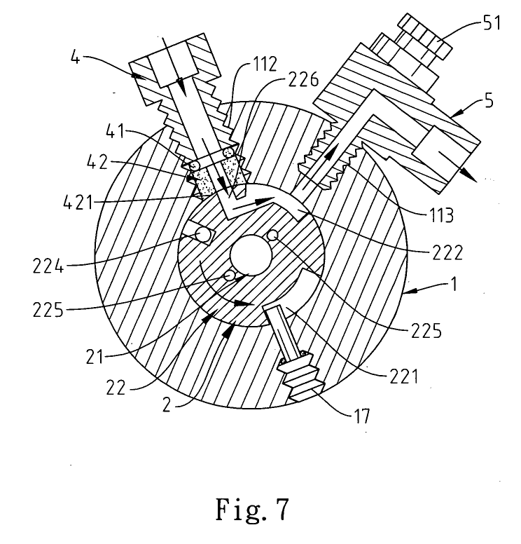

Please refer to FIG. 7, when it is not used for the purpose of dust collection, turn the intake stem 2 to another direction, the collar 22 is turned in the reverse direction, but restricted by the combined action of stop post 17 and the indented recess 221. The closer 42 of the collar 22 will link to guide hole 226, the airflow will go to the first go through hole 112 and the second go through hole 113 finally come out of the nozzle connector 5. The regulator 51 can properly regulate the amount of airflow coming out of the nozzle connector 5. This airflow can be used as a sweeper or as a driving mechanism for other application.

As viewing the above statements, it is apparent that the airflow shaft switch for the compressed air valve is novel design, justified for a grant of new patent.

1. An airflow shift switch for the compressed air valve at least comprises:
a valve seat having a large cavity, said the valve seat has an outer ring with a protruded post, a spring washer placed behind the outer ring; said the spring washer has tow clips to hold the post in place; said the cavity has the first go through hole and the second go through hole linked to the intake connector and the nozzle connector respectively; there is a shield cap beside the outer ring with a catch inside which extends between the gap formed by clips and the post; the shield cap is locked onto the shaft of the intake stem for an integral turning;
the intake stem housed in the cavity of the valve seat includes two parts, the shaft and the collar; on the valve seat side, there is an outer ring with a plurality of skew guide holes, each of which links to the central channel of the shaft; a vacuum chamber will be formed between the outer ring and the valve seat;
on the perimeter of the collar, there is an intake hole in L type design linking to the outer ring; an air hole and a lateral guide chute are provided at vicinity of the intake hole for mutual communication; there is a plurality of skew guide holes which lead the airflow to the outer ring and to the central channel of the shaft;
the retaining assembly comprises an inner board, a sideboard; the inner board is locked to valve seat; the inner board has a protruded post just corresponding to the indented recess on the collar; on the top of the inner board, there is a sideboard which is not locked to the inner board, but to the shaft of the intake stem; when the intake stem is being turned, the sideboard and the shield cap will turn together;
turning the intake stem will link the intake hole with the intake connector, letting airflow entering the intake hole, passing the vacuum chamber, the plural guide holes and finally walking into the central channel of the shaft; the airflow gushing out the guide holes will bring down the airflow on the top of the intake stem, so the dust existing there is therefore brought down with airflow together; when the intake stem is turned to other side, the intake chute on the collar of the intake stem will link to the intake connector and the nozzle connector into a air passage and the airflow ejected can be used a sweeper.

2. The airflow shift switch for the compressed air valve of this invention as claimed in the claim 1 in which the intake stem is further oriented with the retaining assembly; the sideboard provides a through hole corresponding to the indented recess on the inner board; the through hole is installed with spring and ball to be held in the indented recess; a set bolt is used to lock the spring and the ball in place.

3. The airflow shift switch for the compressed air valve of this invention as claimed in the claim 1 in which the end of central channel of the shaft is connected with a guide tube and a muffler which will achieve the noise suppression.
